(19) United States
(12) Patent Application Publication
(10) Pub. No.: US 2024/0413636 A1
(43) Pub. Date: Dec. 12, 2024

(54) HOME APPLIANCE CONTROL SYSTEM AND METHOD

(71) Applicant: LG ELECTRONICS INC., Seoul (KR)

(72) Inventors: Jihye LEE, Seoul (KR); Hyokune HWANG, Seoul (KR); Jung Eun CHOI, Seoul (KR)

(21) Appl. No.: 18/702,121

(22) PCT Filed: Nov. 1, 2022
(86) PCT No.: PCT/KR2022/016862

§ 371 Date: Apr. 17, 2024

(30) Foreign Application Priority Data
Jan. 6, 2022 (KR) 10-2022-0002278

(51) Int. Cl. H02J 3/14

(52) U.S. Cl. CPC H02J 3/14; H02J 2310/14

(57) ABSTRACT

The present disclosure relates to a home appliance control system and method using a user terminal and controlling the operation of the home appliances arranged in a space in consideration of the amount of power consumed in the space. In the present disclosure, if a first home appliance is to be operated, the first home appliance is operated only when the total power consumption of the first home appliance and other home appliances that are already operating is less than or equal to a reference value.

### TECHNICAL FIELD

The present disclosure relates to a home appliance control system and method, more particularly, a system and method for controlling the operation of home appliances in consideration of power consumption when using a plurality of home appliances in one space.

### BACKGROUND ART

There is an increasing interest in space styling to arrange various types of home appliances in one space in a desired combination according to individual tastes and needs.

With recent increase in single-person households, a variety of electric home appliances such as a microwave oven, a refrigerator, a coffee maker, an ice maker, and BT speaker are usually used in one space.

In this regard, there are products that use various home appliances integrally.

As an example, Korean Patent Publication No. 10-2004-0021814 discloses a complex home appliance in which several home appliances are integrated into one system in a limited area at home.

As another example, Korean Patent No. 10-1853880 discloses a stacked platform-based home appliance, which is charged by receiving power based on a stacking method without using a power cord for each home appliance, and supplies power to other stacked home appliances.

However, in the prior art, when many home appliances are used simultaneously in one space, the maximum allowable power of the space is exceeded, resulting in a power shutdown problem.

Accordingly, in the relevant technical field, there is a need for a technique for controlling an operation of a home appliance in consideration of power consumption when a plurality of home appliances are arranged and used in one space.

### DISCLOSURE

### Technical Problem

The present disclosure provides a home appliance control system and a control method for controlling operation of home appliances in consideration of power consumption in a space when a plurality of home appliances are used in one space.

The present disclosure provides a home appliance control system and a control method for controlling operation of a plurality of home appliances in consideration of a maximum allowable power in one space.

### Technical Solution

In the home appliance control system and method according to an embodiment of the present disclosure, an operation of a plurality of home appliances is controlled using a user terminal.

When a user inputs a control command for the operation of the home appliance into a user terminal, the user terminal transmits the control command to a server, and the server controls the operation of the home appliance according to the control command.

A plurality of home appliances may be arranged in one space, and may perform communication with the user terminal and the server. The user terminal also communicates with the home appliances and the server. The user terminal registers information of the plurality of home appliances in the server.

When an operation of a first home appliance among the plurality of home appliances is requested according to a manipulation input of the user, the user terminal transmits the control command for the operation of the first home appliance to the server. When the control command is received, the server determines whether a home appliance other than the first home appliance is in operation. If another home appliance is operating, the server determines whether the total power consumption expected in a space exceeds a preset reference value when the first home appliance is additionally operated, the server operates the first home appliance only if the reference value is not exceeded.

If the expected total power consumption exceeds the reference value, the first home appliance is not operated. Accordingly, power shutdown may be prevented by preventing the total power consumption from exceeding the reference value during the additional operation of the first home appliance.

In this case, when the first home appliance is not operated, a notification is output from the first home appliance and the user terminal to inform the user of this situation.

In addition, when the first home appliance is not operated, an operation reservation may be input so that the first home appliance may be operated under a specific condition. When the operation reservation of the first home appliance is input, it is determined whether at least one of the other appliances already in operation stops operating, and whether the expected total power consumption in the space exceeds the reference value when the first appliance is additionally operated. The first home appliance is operated only if it does not exceed the reference value.

This is also to prevent the total power consumption from exceeding the reference value by additional operation the first home appliance even if one of the other home appliances already in operation stops operating.

In this case, the above total power consumption may be the total average power consumption of other home appliances and the first home appliance that are operating in the space, or may be the total maximum power consumption of other home appliances and the first home appliance operating in the space.

The user terminal may display the images of the home appliances on the screen in the same position as the position where a plurality of home appliances arranged in one space are actually arranged.

And, when an image of the home appliance is touched according to the user's manipulation input, the user terminal transmits the control command for the operation of the home appliance to the server, and the server may operate the home appliance according to the control command.

### Advantageous Effect

According to the present disclosure, it is possible to prevent power shutdown that may occur when several home appliances are used in one space.

According to the present disclosure, as the operation of home appliances is controlled in consideration of the amount of power consumed during the operation of the home appliances, power consumption may be reduced.

The present disclosure controls the operation of the home appliances according to the maximum allowable power in the space, thereby enabling safe use of home appliances.

### DESCRIPTION OF DRAWINGS

FIG. 1 is a schematic configuration diagram of a home appliance control system according to an embodiment of the present disclosure.

FIG. 2 is an exemplary view in which home appliances are arranged in one space according to the embodiment of the present disclosure.

FIG. 3 is a block diagram of the configuration of the home appliance control system according to the embodiment of the present disclosure.

FIG. 4 is an exemplary screen view of a user terminal showing an example of registering an arrangement of a plurality of home appliances in the system for controlling home appliances according to the embodiment of the present disclosure.

FIG. 5 is an exemplary screen view of the user terminal showing an example of registering a plurality of home appliances in a server in the home appliance control system according to the embodiment of the present disclosure.

FIG. 6 is an exemplary screen view of the user terminal showing an example of operating a plurality of home appliances in the home appliance control system according to the embodiment of the present disclosure.

FIG. 7 is a flowchart illustrating a method for controlling home appliances according to an embodiment of the present disclosure.

FIG. 8 is a flowchart illustrating a method for controlling home appliances according to another embodiment of the present disclosure.

FIG. 9 is a flowchart illustrating a method for controlling home appliances according to another embodiment of the present disclosure.

### BEST MODE

Hereinafter, some embodiments of the present disclosure will be described in detail with reference to exemplary drawings. In adding reference numerals to the components of each drawing, it should be noted that the same components have the same reference numerals as much as possible, even if they are displayed in different drawings. In addition, in describing the embodiment of the present disclosure, if it is determined that the detailed description of the relevant known configuration or function interferes with the understanding of the embodiment of the present disclosure, the detailed description will be omitted.

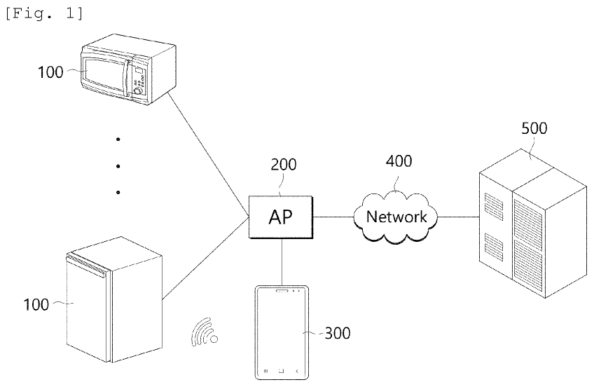

FIG. 1 is a block diagram of a home appliance control system according to an embodiment of the present disclosure.

Referring to FIG. 1, the home appliance control system according to the embodiment of the present disclosure includes a plurality of home appliances 100, an AP device 200, a user terminal 300, a network 400, and a server 500.

The home appliance 100 is a home appliance generally used in a home, and may be, for example, a refrigerator, a coffee maker, a microwave oven, an air purifier, and the like.

In the present embodiment, the home appliance 100 is at least two or more, all of which are arranged in one space. For example, some home appliances 100 may be stacked.

The home appliance 100 includes a communication module and may communicate with the user terminal 300 and the server 500.

The home appliance 100 may communicate directly with the user terminal 300, or may communicate with user terminal 300 and server 500 by connecting to the network 400 through the access point device (AP) 200.

The user terminal 300 is a device having a communication function and may communicate with the home appliance 100 and the server 500.

The user terminal 300 may communicate with the server 500 through the network 400, such as LTE or 5G.

The user terminal 300 may communicate with the home appliance 100 through the AP device 200 by using, for example, Wi-Fi communication, and may communicate with the home appliance 100 through the server 500 by using the network 400.

The user terminal 300 may directly communicate with the home appliance 100 by using, for example, Bluetooth communication.

The user terminal 300 may be installed with a program or a dedicated application (hereinafter, referred to as a dedicated app) for operating and controlling the home appliance 100.

The user terminal 300 may execute the dedicated app to transmit a control command for an operation to the home appliance 100 and receive data from the home appliance 100.

In this embodiment, the user terminal 300 may be an electronic device such as a smartphone, a tablet, a PDA, a computer, a laptop, or a wearable device such as a smart watch.

The user terminal 300 may transmit the unique information of the home appliance 100 to the server 500 to register the corresponding home appliance 100 in the server 500.

In this embodiment, the user terminal 300 may receive and display a web page or an application screen including information of the home appliance 100 from the server 500.

The server 500 may communicate with the home appliance 100 and the user terminal 300 to receive and store information, and may return information requested from the user terminal 300.

The server 500 may receive a control command for the operation of the home appliance 100 requested from the user terminal 300 and control the operation of the home appliance 100 according to the control command.

The server 500 may store information of the home appliance 100 registered by the user terminal 300 in a database (DB), receive data transmitted in real time from the home appliance 100, and update information of the home appliance 100 in real time.

The server 500 may be implemented as a single device, or may be implemented as a distributed processing system in which a plurality of server devices are interconnected to distribute the requested data in a plurality of server devices.

The server 500 may be a cloud service-based server system or a web server. Accordingly, data related to a web page associated with the home appliance 100 may be provided to the user terminal 300.

The server 500 may store firmware information and operation information of the home appliance 100, and register product information of the home appliance 100. For example, the server 500 may be a server operated by a manufacturer of the home appliance 100, or may be a server operated by an open application store operator or a service provider providing services related to the home appliance 100.

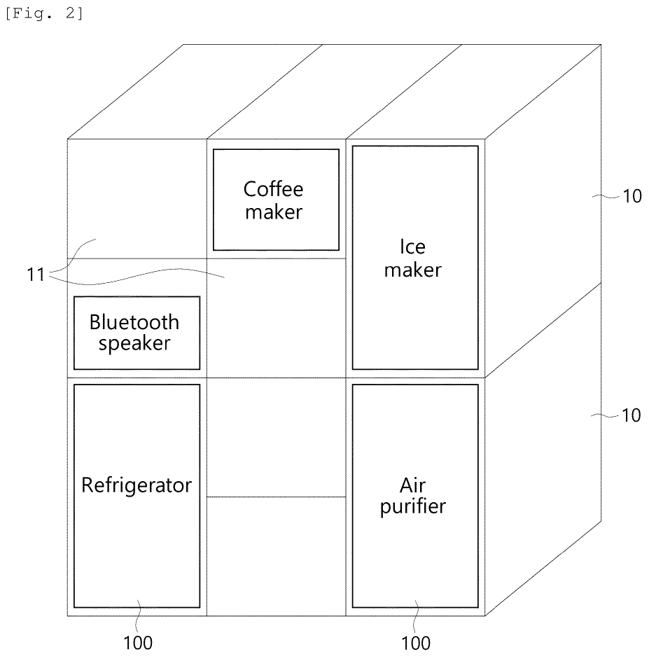

FIG. 2 is an exemplary view in which home appliances are arranged in one space according to the embodiment of the present disclosure.

When many home appliances 100 are used in one space as in the example of FIG. 2, in order to efficiently use the space, the home appliance 100 may be inserted into the space 11 according to the shape of each space 11 by using a frame 10 partitioned into the plurality of spaces 11.

The frame 10 is composed of a plurality and may be separated and combined to each other. Accordingly, each frame 10 may be disposed at a different position according to the position of the home appliances 100 to be arranged.

When the home appliances 100 arranged in one space are operating, the maximum allowable power of the space may be exceeded. Therefore, when some or all of the home appliances 100 are used simultaneously, it is necessary to consider the maximum allowable power of the space.

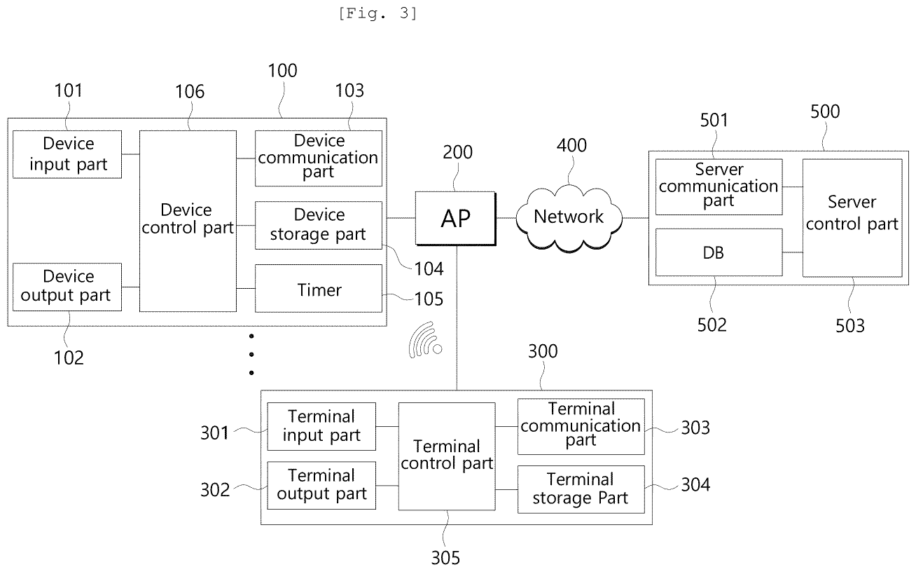

FIG. 3 is a block diagram of the home appliance control system according to the embodiment of the present disclosure.

Referring to FIG. 3, the home appliance 100 constituting the home appliance control system of the present disclosure includes a device input part 101, a device output part 102, a device communication part 103, a device storage part 104, a timer 105, and a device control part 106.

The device input part 101 receives a user's manipulation. The user may input the information of the home appliance 100 through the device input part 101 to register the home appliance 100 in the server 500.

The device output part 102 may display information, operation information, and state information of the home appliance 100, and the like. The user may identify an operating state and a current state of the home appliance 100 through information displayed on the device output part 102.

The device communication part 103 may communicate with the server 500 and the user terminal 300 through the AP device 200. The device communication part 103 may directly communicate with the user terminal 300.

The device communication part 103 includes, for example, one or more of a Bluetooth communication module, a Wi-Fi communication module, a Zigbee communication module, and an NFC communication module.

The device storage part 104 includes data and programs necessary for the unique information and operation of the home appliance 100.

The device storage part 104 stores the average power consumption amount of the home appliance 100 and the maximum power consumption amount for each of the plurality of functions.

When the home appliance 100 operates, various functions may be executed, and the maximum power consumption refers to a value at which the power consumption for a particular function is the maximum.

For example, when an air purifier is turned on and operating, the amount of power consumed in air purifying mode 1 and air purifying mode 4 may be different. The amount of power consumed in mode 4 may be greater than in mode 1. Power consumption may be maximized in maximum strong wind. The maximum power consumption may be different for each function.

The timer 105 may count an elapsed time under the control of the device control part 106. The counted time may be transmitted to the device control part 106.

The device control part 106 controls the overall operation of the home appliance 100.

The device control part 106 may register the home appliance 100 in the server 500 by registering the information of the home appliance 100 stored in the device storage part 103 to the server 500 according to the user's manipulation input.

The device control part 106 controls the operation of the home appliance 100 when a control command for the operation of the home appliance 100 is received from the user terminal 300 and the server 500.

The device control part 106 may operate the home appliance 100 according to preset operating conditions, including turning on/off of the home appliance 100. For example, in the case of an air purifier, the device control part 106 may turn on the air purifier and operate it in a preset air purifying mode 1.

The control command for the operation of the home appliance 100 may be set such that one step is performed or several steps may be continuously performed.

For example, when a control command to turn on the air purifier is received, the device control part 106 may turn on the air purifier to operate in a preset mode.

As another example, when a control command is received to turn on the air purifier at 10:00 a.m. to operate in air purifying mode 3, to switch to air purifying mode 1 30 minutes later, and to turn it off after 1 hour, the device control part 106 may control the above steps to proceed by using the timer 105.

The device control part 106 transmits operation information according to the operation of the home appliance 100 to the server 500. The operation information may include various types of information on operations and states of the home appliance 100, such as the location of the home appliance 100, whether it is on/off, an operation time, and an operation mode.

The user terminal 300 constituting the embodiment of the home appliance control system of the present disclosure includes a terminal input part 301, a terminal output part 302, a terminal communication part 303, a terminal storage part 304, and a terminal control part 305.

The terminal input part 301 receives the user manipulation. The user may input a control command for the operation of the home appliance 100 through the terminal input part 301.

The terminal output part 302 may display the state information and the control process of the home appliance 100 on a screen. Such state information may include a location, an on/off state, an operation time, an operation mode, and the like of the home appliance 100.

In this embodiment, the terminal input part 301 and the terminal output part 302 may be implemented as an integral or one module. When the output part 302 and a touch sensor for sensing a touch operation form a layer structure to form a touch screen, the output part 302 may also be used as the input part 301. The touch sensor may be in the form of a touch film, a touch sheet, a touch pad, and the like.

For example, the terminal communication part 303 may perform direct communication with the home appliance 100 through Wi-Fi Direct, and communicate with the home appliance 100 and the server 500 through the AP 200 and the network 400. In addition, the terminal communication part 303 may also communicate directly with the server 500 through the network 400 without connection to the AP 200.

The terminal storage part 304 may store a dedicated application program and may store information on the user terminal 300 and the home appliance 100.

The terminal control part 305 controls the overall operation of the user terminal 300.

The terminal control part 305 may execute the dedicated app stored in the storage part 304 according to a user manipulation input to the input part 301.

The terminal control part 305 may register the home appliance 100 in the server 500 by registering the information of the home appliance 100 through the terminal input part 301 according to user manipulation.

The information of the home appliance 100 may include information such as a location of the home appliance 100, product information, an average power consumption, and a maximum power consumption.

The terminal control part 305 may transmit control commands and operation information for the operation of the home appliance 100 to the home appliance 100 and the server 500 by using the dedicated app, and display information received from the home appliance 100 and the server 500 on the output part 302.

For example, the terminal control part 305 may transmit the location, on/off, operation mode, operation time, etc. of the home appliance 100 to the server 500 and/or the home appliance 100.

The terminal control part 305 may transmit a control command to automatically perform the operation mode of each step from ON to OFF of the home appliance 100.

The terminal control part 305 may control a web page or application screen including information of the home appliance 100 to be displayed on the output part 302 according to the user manipulation input.

For example, the terminal controller 305 may control the location, the operation state, and the operation information of the home appliance 100 to be displayed on the output unit 302.

In addition, the terminal control part 305 may output the image of the home appliance 100 on the screen of the terminal output part 302 at the same location where the plurality of home appliances 100 are actually arranged by the user's manipulation input. This is to ensure that the actual arrangement of the home appliance 100 and the arrangement of the image of the home appliance 100 in the terminal output part 302 are the same.

The server 500 constituting the embodiment of the home appliance control system of the present disclosure is configured to include a server communication part 501, a database (DB) 502, and a server control part 503.

The server communication part 501 may communicate with the home appliance 100 and the user terminal 300 through the network 400.

The server communication part 501 may receive a control command for the operation of the home appliance 100 from the user terminal 300 and the server 500 and transmit the control command to the home appliance 100.

The database (DB) 502 may store various types of information about the server 500, the home appliance 100, and the user terminal 300.

The DB 502 may store mapping information between the user terminal 300 and the home appliance 100. This is to map and store the identification information of the user terminal 300 and the home appliance 100, so that the home appliance 100 controlled and managed by the user terminal 300 is mapped to each other.

DB 502 also stores Information about the home appliance 100 and the user terminal 300.

The information of the home appliance 100 includes unique information of the home appliance 100, arrangement location, product information, operation information, state information, an average power consumption, a maximum power consumption, and a maximum allowable power in a specific space.

In this case, a specific space may be specified by the user terminal 300, and the user may designate the specific space through the user terminal 300 and register it in the server 500. In addition, the maximum allowable power information set in the specific space may also be registered in the server 500.

The server control part 503 may control the overall operation of the server 500.

The server control part 503 may perform authentication according to a request for authentication of the user terminal 300 and the home appliance 100, map the user terminal 300 and the home appliance 100 using identification information of the user terminal 300 and the home appliance 100, and store the mapped result in the DB 502.

The server control part 503 may store various types of information transmitted from the home appliance 100 through the network 400 in the DB 502.

The server control part 503 may receive a control command for the operation of the home appliance 100 from the user terminal 300 and transmit the control command to the home appliance 100, or control the operation of the home appliance 100 according to the control command.

In this case, when a control command for the operation of the home appliance 100 is received from the user terminal 300, the server control part 503 may operate the home appliance 100 according to the control command based on the information of the home appliance 100 stored in the DB 502.

For example, when a control command for turning on the home appliance 100 is received from the user terminal 300, the server controller 503 may compare the average power consumption or the maximum power consumption of the home appliance 100 with a preset maximum allowable power amount to determine whether the home appliance 100 is turned on or off.

The server control part 503 may return information of the home appliance 100 to the user terminal 300 according to a request from the user terminal 300. For example, information such as a location, an on/off state, an operation state, and operation information of the home appliance 100 may be returned.

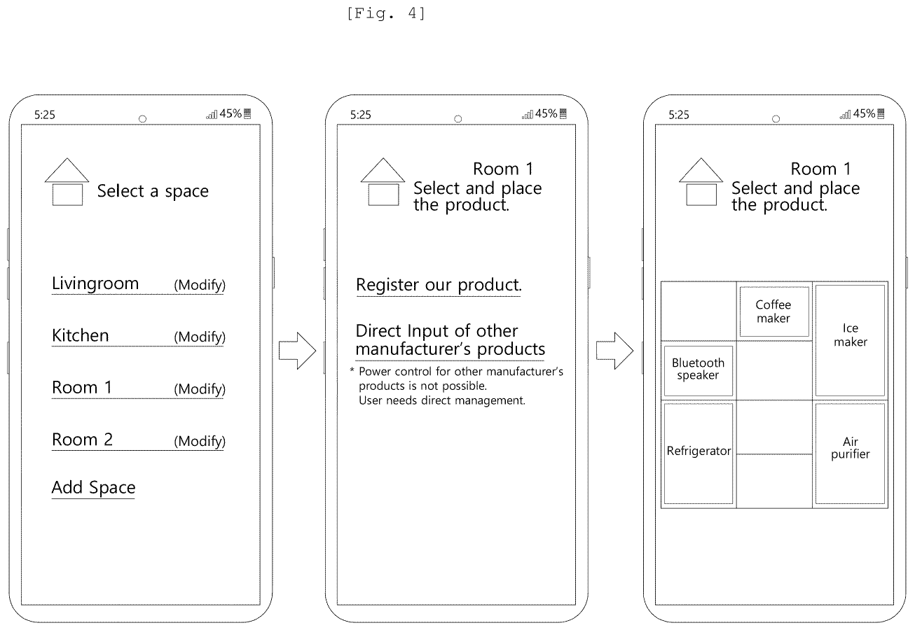

FIG. 4 is an exemplary screen view of the user terminal showing an example of registering the arrangement of a plurality of home appliances in the home appliance control system according to the embodiment of the present disclosure.

The user may access the server 500 by logging in after registering as a member by executing a dedicated app on the user terminal 300.

The user first selects a space in which the home appliance 100 is to be arranged, and arranges the home appliance 100 in the selected space. Then, the home appliance 100 is virtually placed on the dedicated app at the same location where the home appliance 100 is actually placed.

In the user terminal 300, an image of the home appliance 100 arranged to be the same as the actual location is displayed on the terminal output unit 302.

Accordingly, the actual arrangement location of the home appliance 100 and the virtual arrangement location may be synchronized. The virtual arrangement location is registered in the server 500.

The registered virtual arrangement location may be changed. It is also possible to additionally register, delete, and change the location of the home appliance in the virtual arrangement location. The location of the home appliance may be moved by touching the home appliance to be moved and dragging it to a position to be moved.

When the arrangement of the home appliance 100 on the dedicated app is completed, the information of the home appliance 100 is registered in the server 500.

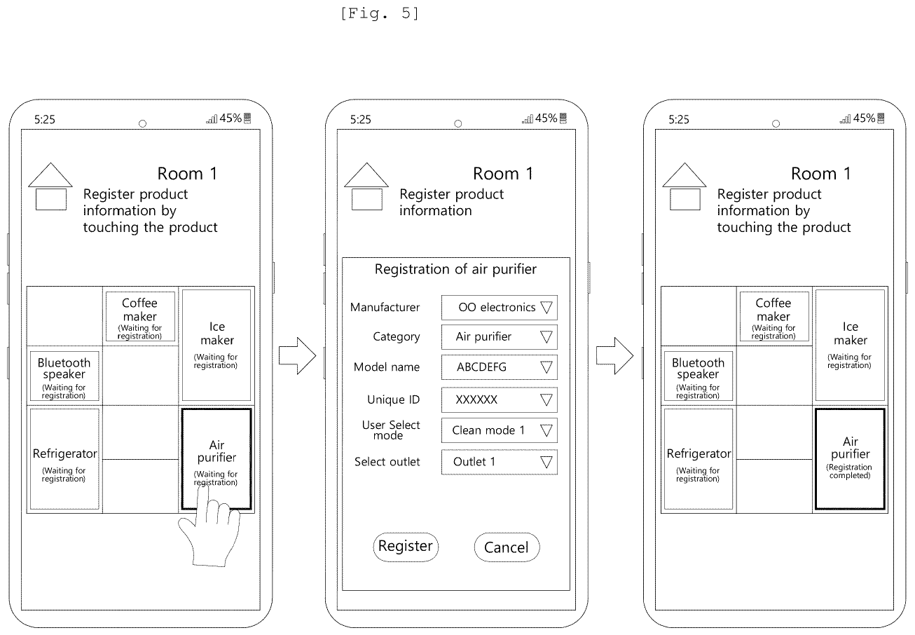

FIG. 5 is a screen view of the user terminal showing an example of registering a plurality of home appliances in the server in the home appliance control system according to the embodiment of the present disclosure.

In a state where the arrangement of the home appliance 100 is completed, the information of the home appliance 100 may be registered in the server 500 by touching the image of the home appliance 100 on the displayed screen.

In an example of FIG. 5, an example of registering information of an air purifier is illustrated.

When the air purifier is touched, the screen for registering information of the air purifier is changed and displayed. For example, information such as a manufacturer, a category, a model name, a unique ID, a user selection operation, and a use outlet may be selected or input on the screen.

Here, the user selection operation is to set the operation mode in advance when operating the corresponding home appliance 100, and the use outlet is to input which outlet is used among the outlets provided in the space.

When the product registration of the home appliance 100 is completed, it is displayed on the screen that the registration is completed. Another home appliance 100 waiting for registration may be registered in the same way.

When the registration of information of the home appliance 100 is completed, the user may operate the home appliance 100 registered through the user terminal 300.

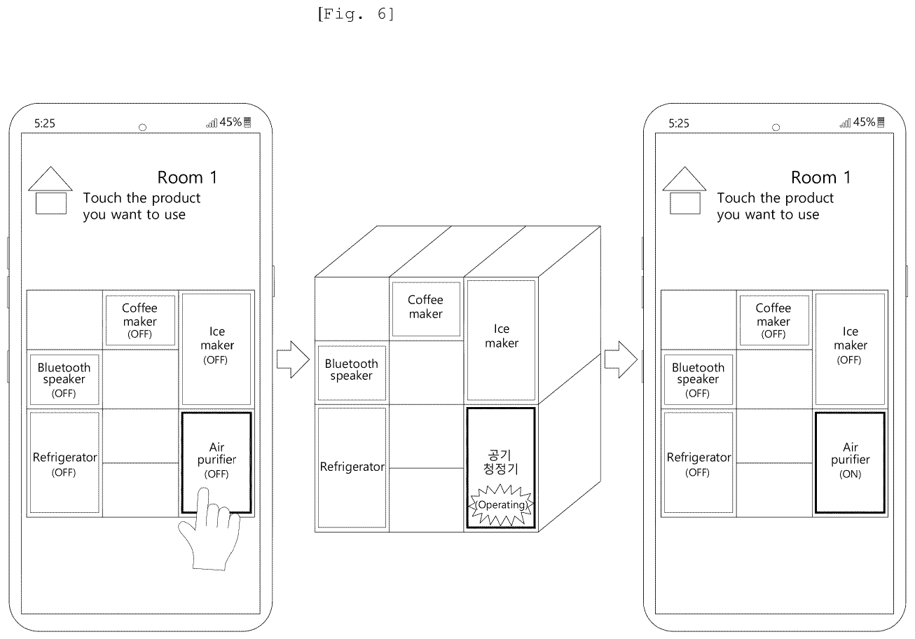

FIG. 6 is a screen view of the user terminal showing an example of operating a plurality of home appliances in the home appliance control system according to the embodiment of the present disclosure.

Referring to FIG. 6, when the user executes the dedicated app on the user terminal 300 and touches an image of the home appliance 100 on the screen, the corresponding home appliance 100 is actually operated.

That is, when the image of the home appliance 100 is touched, the user terminal 300 transmits a control command for the operation of the home appliance 100 to the server 500, the server 500 transmits the control command to the home appliance 100, and the home appliance 100 operates according to the received control command.

The drawing shows an example of turning on an air purifier as an example. When the user touches the air purifier displayed on the user terminal 300, a control command to turn for turning on the air purifier is transmitted to the air purifier through the server 500, and the air purifier is turned on.

When a home appliance 100 is operated, it is displayed on the screen of the user terminal 300 that the corresponding home appliance is in operation.

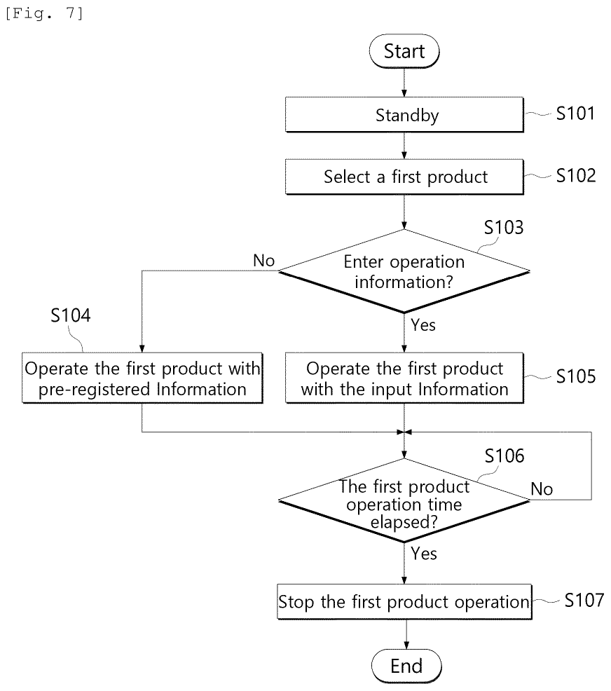

FIG. 7 is a flowchart illustrating a home appliance control method according to an embodiment of the present disclosure.

Referring to FIG. 7, in the home appliance control method of the present disclosure, the standby state of step S101 is a state in which the user logs in after joining a member, places the home appliance 100 in the dedicated app to match the actual location of the plurality of home appliances 100, and completes registration of information of the home appliance 100 in the server 500.

A first product is selected among the home appliances 100 in the user terminal 300 at S102, and it is checked whether operation information of the first product is input at S103.

If the operation information is not input, the user terminal 300 transmits a control command for the operation of the first product to the server 500 to operate with a previously registered information, and the server 500 operates the first product with the previously registered information according to the control command at S104.

When operation information is input, the user terminal 300 transmits a control command for the operation of the first product to the server 500 to operate with the input information, and the server 500 operates the first product according to the input information at S105.

When an operation time of the first product elapses at S106, the server 500 stops the operation of the first product at S107.

As described above, in the present disclosure, the user may remotely operate the home appliance 100 by executing the dedicated app on the user terminal 300 and touching the home appliance selected from the plurality of home appliances 100.

At this time, even if the user touches the home appliance on the screen of the user terminal 300, the home appliance is actually operated only if a specific condition is satisfied.

That is, when the user touches a particular home appliance, the server 500 determines whether to operate the particular home appliance in consideration of the amount of power required to operate the touched home appliance.

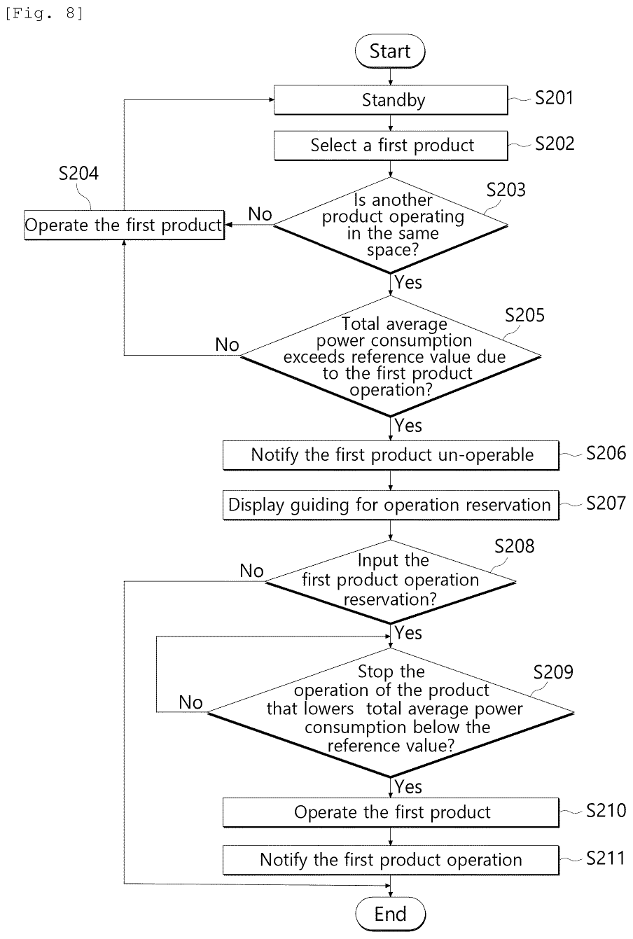

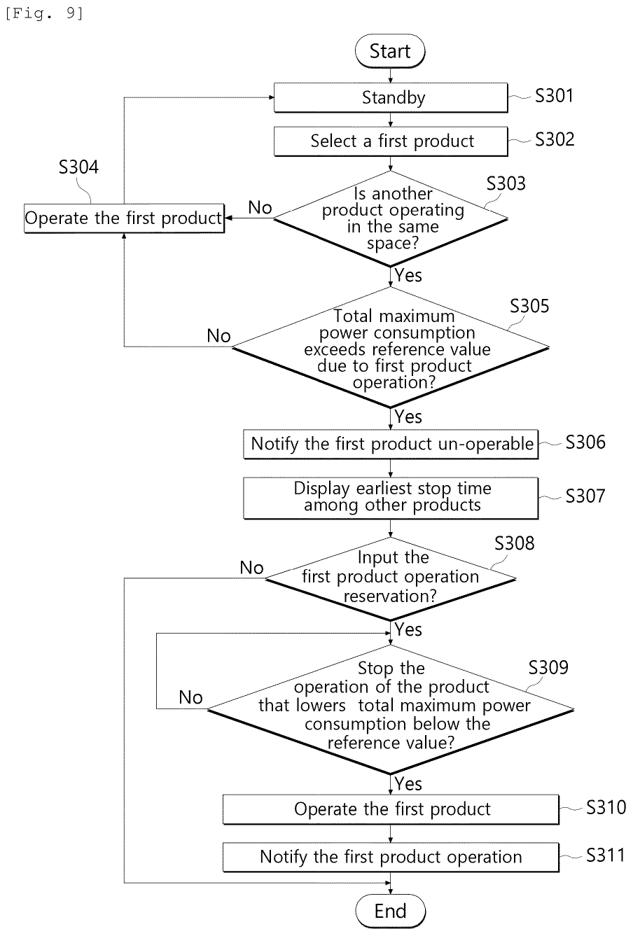

This operation will be described in more detail with reference to FIGS. 8 and 9.

FIG. 8 is a flowchart of the home appliance control method according to another embodiment of the present disclosure.

Referring to FIG. 8, in a standby state where the home appliance 100 is registered in the server 500 at S201, when a first product of the home appliance 100 is selected in the user terminal 300 at S202, the user terminal 300 transmits a control command for the operation of the first product to the server 500, and the server 500 determines whether another product is already operating in the same space as the first product at S203.

If another product is not in operation, the server 500 operates the first product according to the control command at S204.

However, if the other product is already in operation, the server 500 determines whether the total average power consumption in the space exceeds a reference value (maximum allowable power in the set space) when the first product is operated at S205.

Here, the total average power consumption in the space is the sum of the average power consumption for each product operating in the space.

If the total average power consumption in the same space exceeds the reference value during operation of the first product, the server 500 outputs a notification of non-operation of the first product to the user terminal 300 and the first product. The user terminal 300 and the first product output the notification of non-operation to the outside to notify the user at S206.

This is to prevent power shutdown problems from exceeding the maximum allowable power in the space when the first product operates while other products are operating.

For example, three products A, B, and C are placed in one space and the maximum allowable power of space is 3300W. The average power consumption of product A, B, and C is 1500W, 500W, and 2000W, respectively. In this case, when product A is touched on the screen of the user terminal 300, the server 500 checks the average power consumption of A product (1.5 kW) and operates product A because it is equal to or less than the preset maximum allowable power (3.3 kW).

After that, when product B is touched while product A is operating, the server 500 confirms that the total average power consumption (1.5+0.5=2.0 kW) expected when products A and B operate at the same time is equal to or less than the maximum allowable power (3.3 kW), and also operates product B.

However, if product C is touched while products A and B are operating, the server 500 checks that the expected total average power consumption (1.5+0.5+2.0=4.0 kW) during the operation of products A, B, and C exceeds the maximum allowable power, and does not operate product C.

In this case, in FIG. 8, the first product may be reserved to operate when a specific condition is met.

Specifically, an operation reservation of the first product is input in the user terminal 300 by the user at S208. When there are other products currently in operation and the first product is additionally reserved to operate, the server 500 operates the first product at S210 when a product that makes the total average power consumption expected in the space below the reference value is stopped at S209. When the first product is operated, the server 500 transmits a notification of the operation to the user terminal 300 and the first product, and the user terminal 300 and the first product output the notification to the outside so that the user is notified at S211.

In the above example, even if product C is touched while products A and B are operating, product C does not operate because the expected total average power consumption exceeds the maximum allowable power. However, when at least one of products A and B is stopped, it is reserved to operate product C.

Even in this case, the operation of product C is determined by comparing the total average power consumption at the time of operation of product C with the maximum allowable power.

For example, if product B is stopped while products A and B are operating, and product C is subsequently operated, the total average power consumption of products A and C becomes 3.5 kW (=1.5 kW+2.0 kW) and exceeds the maximum allowable power (3.3 kW), so product C may not be operated.

However, if product A is stopped while products A and B are operating, and product C is subsequently operated, the total average power consumption of products B and C becomes 2.5 kW (=0.5 kW+2.0 kW), which is equal to or less than the maximum allowable power, so product C may be operated.

FIG. 9 is a flowchart illustrating the home appliance control method according to another embodiment of the present disclosure.

Referring to FIG. 9, when a first product is selected at S302 from a plurality of home appliances 100 in a standby state at S301, the user terminal 300 transmits a control command for the operation of the first product to the server 500, and the server 500 determines whether another product is already operating in the same space as the first product at S303.

If another product is not operating in the same space, the server 500 operates the first product according to the control command at S304.

However, if another product is already operating in the same space, the server 500 determines whether the expected total maximum power consumption in the space exceeds the reference value (maximum allowable power) when the first product is operated at S305.

If the total maximum power consumption in the same space exceeds the reference value during operation of the first product, the server 500 outputs a notification of non-operation of the first product to the user terminal 300 and the first product. The user terminal 300 and the first product output a notification of non-operation to the outside to notify the user at S306.

This is to prevent power shutdown problems from occurring when the first product operates while another product is operating and the total maximum power consumption exceeds the maximum allowable power in the space.

For example, in the above example, product B has an average power consumption of 500W, but it is assumed that the maximum power consumption is temporarily 800W when operating a specific function, and product C has an average power consumption of 2000W, but the maximum power consumption is temporarily 2600W when operating a specific function.

In this case, if product C is to be operated while product B is operating, the average power consumption of products B and C are 2.5 KW (0.5 KW+2.0 KW), which is less than the maximum allowable power (3.3 KW). However, when operating a specific function, the maximum power consumption of products B and C is 3.4 KW (=0.8 kW+2.6 kW) temporarily, so the maximum allowable power (3.3 kW) is exceeded, and product C may not be operated.

When the operation of the first product is not possible, the server 500 may selectively transmit the time of the product that is stopped earliest among other products in operation to the user terminal 300 and the first product, and the user terminal 500 and the first product may display it at S307. The operation time is predetermined for each product, and may be automatically stopped when the operation time elapses.

In this case, the first product may be reserved to operate when a specific condition is met.

Specifically, an operation reservation of the first product is input in the user terminal 300 by the user at S308. When there are other products currently in operation and the first product is additionally reserved to operate, the server 500 operates the first product at S310 when a product that makes the maximum power consumption expected in the space equal to or below the reference value is stopped at S309. Then, the server 500 transmits a notification of the operation to the user terminal 300 and the first product, and the user terminal 300 and the first product output the notification to the outside so that the user is notified at S311.

As another example, assuming that product A's average power consumption is 1500W, maximum power consumption is 1600W, product B's average power consumption is 500W, maximum power consumption is 700W, and product C's average power consumption is 2000W, and maximum power consumption is 2200W, when product B is stopped while products A and B are operating and product C reserved for operation is operating, the maximum power consumption of products A and C is 3.8 kW (=1.6 kW+2.2 kW), exceeding the maximum allowable power, so product C may not be operated.

However, if product A is stopped while products A and B are operating, and even if product C is operated, the maximum power consumption of product B and C becomes 2.9 kW (=0.7 kW+2.2 KW), which is equal to or less than the maximum allowable power consumption, so product C may be operated.

As shown in FIGS. 8 and 9, in the home appliance control method of the present disclosure, when operating home appliances arranged in one space, the average power consumption and the maximum power consumption of the home appliance are compared with a preset maximum allowable power consumption to determine whether to operate.

In this case, if some of the home appliances in operation are stopped and afterwards another home appliance is operated, the average power consumption and maximum power consumption of the home appliance to be operated is compared with the preset maximum allowable power consumption to determine whether the home appliance operates or not.

Accordingly, it is possible to solve the power shutdown concern in advance due to the operation of home appliances arranged in one space.

Although the embodiments of the present disclosure have been described above with reference to the accompanying drawings, the present disclosure is not limited to the above embodiments, but may be manufactured in various forms, and those of ordinary skill in the art to which the present disclosure pertains will understand in other specific forms without changing the technical spirit or essential features of the present disclosure. Therefore, it should be understood that the embodiments described above are exemplary and not limited in all respects.

1. A home appliance control method, the method comprising:
requesting operation of a first one of a plurality of home appliances;
determining whether at least a second one of the home appliances other than the first one of the home appliance are operating;
determining whether a total power consumption value expected during operation of the first one of the home appliances exceeds a preset reference value when the at least second one of the home appliances is operating; and
controlling operation of the first one of the home appliances based on the determination that the total power consumption value does not exceed the reference value.

2. The method of claim 1, wherein the controlling operation of the first one of the home appliances includes controlling the first one of the home appliances to not operate based on the determination that the total power consumption value exceeds the reference value.

3. The method of claim 2, comprising providing a notification from the first one of the home appliances and a user terminal when the first one of the home appliances is controlled to not operate.

4. The method of claim 2, wherein when the controlling operation of the first one of the home appliances includes controlling the first one of the home appliances to not operate, the method further comprising:
receiving an input of an operation reservation of the first one of the home appliances;
stopping operation of at least one of the at least second one of the home appliances that is in operation;
determining whether the expected total power consumption value during operation of the first one of the home appliances exceeds the reference value; and
operating the first one of the home appliances when the expected total power consumption value is determined to not exceed the reference value.

5. The method of claim 1, wherein the total power consumption value is based on a total average power consumption value of all of the plurality of home appliances that are in operation.

6. The method according to claim 1, wherein the total power consumption value is based on a total maximum power consumption value of all of the plurality of home appliances that are in operation.

7. A home appliance control system comprising:
a plurality of home appliances that includes a first home appliance and at least a second home appliance;
a user terminal configured to provide a control command for operation of at least one of the home appliances; and
a server configured to receive the control command from the user terminal and to control an operation of the at least one of the home appliances based on the control command,
wherein when a control command for the operation of the first home appliance is received, the server determines whether the second home appliance is operating, and operates the first home appliance when a total power consumption value expected during operation of the first home appliance does not exceed a preset reference value.

8. The system of claim 7, wherein the server operates the first home appliance when the second home appliance is not in operation.

9. The system of claim 7, wherein the server does not operate the first home appliance when the second home appliance is operating and the total power consumption value exceeds the reference value.

10. The system of claim 9, wherein when an operation reservation of the first home appliance is received while the server does not operate the first home appliance, at least one of the second home appliance in operation stops operating, and the expected total power consumption value during operation of the first home appliance does not exceed the reference value, the server operates the first home appliance.

11. The system of claim 7, wherein the total power consumption value is based on a total average power consumption value of all of the plurality of home appliances that are in operation.

12. The system of claim 7, wherein the total power consumption value is based on a total maximum power consumption value of all of the plurality of home appliances that are in operation.

13. The system of claim 7, wherein the user terminal displays images of the home appliances on a screen at a same location as a location where the plurality of home appliances are arranged.

14. The system of claim 13, wherein when an image of the specific home appliance on the screen is touched, the user terminal transmits, to the server, a control command for operation of the specific home appliance, and the server operates the specific home appliance based on the control command.

15. The method of claim 3, wherein the total power consumption value is based on a total average power consumption value of all of the plurality of home appliances that are in operation.

16. The method of claim 3, wherein the total power consumption value is based on a total maximum power consumption value of all of the plurality of home appliances that are in operation.

17. The system of claim 9, wherein the total power consumption value is based on a total average power consumption value of all of the plurality of home appliances that are in operation.

18. The system of claim 10, wherein the total power consumption value is based on a total average power consumption value of all of the plurality of home appliances that are in operation.

19. The system of claim 9, wherein the total power consumption value is based on a total maximum power consumption value of all of the plurality of home appliances that are in operation.

20. The system of claim 10, wherein the total power consumption value is based on a total maximum power consumption value of all of the plurality of home appliances that are in operation.
